(19) United States
(12) Patent Application Publication
(10) Pub. No.: US 2008/0230576 A1
(43) Pub. Date: Sep. 25, 2008

(54) Vehicle Tire Cover

(76) Inventor: Mark J. Arabadjis, Holmdel, NJ (US)

Correspondence Address: DEMONT & BREYER, LLC, 100 COMMONS WAY, Ste. 250, HOLMDEL, NJ, 07733, US

(21) Appl. No.: 11/688,754

(22) Filed: Mar. 20, 2007

(51) Int. Cl. B62D 43/00; B60B 7/00

(52) U.S. Cl. 224/42.2

(57) ABSTRACT

A vehicle tire cover for covering a spare tire is disclosed. The tire cover is physically adapted to display an image and is further adapted to enable a vehicle owner to routinely and rapidly change the image. In some embodiments, the cover includes a pouch having a transparent window for displaying the image. The pouch includes a closure mechanism that provides access to the interior of a pouch without removing the tire cover from a spare tire.

### FIELD OF THE INVENTION

The present invention relates to automotive products in general, and, more particularly, to a vehicle tire cover.

### BACKGROUND OF THE INVENTION

The cargo or passenger capacity of a sport utility vehicle can be increased by removing the spare tire from inside of the vehicle and moving it to an alternate location on the vehicle. In such cases, the spare tire is typically relocated to an external mounting bracket that is disposed on the rear hatch of the vehicle.

In order to protect such an externally-carried tire from UV radiation, smog, moisture, dirt and dust, the tire is often fitted with a cover. Although hard-shelled, spare-tire covers were popular in the past, soft and flexible designs are now favored. These soft, flexible covers offer substantial savings in weight and cost relative to a hard-shelled cover, and can be quickly and easily affixed to a spare tire. Flexible covers are particularly appealing to the after-market automotive-supply industry since, relative to hard covers, packaging, shipping and shelving costs as well as shelf space requirements are reduced.

In addition to the utilitarian benefits it provides, a tire cover additionally enhances the aesthetics of the vehicle by concealing the otherwise exposed spare tire and wheel. Furthermore, tire covers often bear advertising or art, that latter serving as a way for a vehicle owner to personalize their vehicle.

With regard to art-bearing tire covers, the artwork is usually printed directly onto the tire cover. On the other hand, a decorative tire cover that displays artwork from within the cover is disclosed in U.S. Pat. No. 5,996,863. In accordance with that patent, the tire cover has a large, central opening through which the artwork is displayed. Inner and outer annular mounting rings secure the artwork to the tire cover and inner and outer protective covers shield the art work from the elements. It appears that the tire cover must be removed form the spare tire in order to change the artwork.

Notwithstanding a stated objective in U.S. Pat. No. 5,996,863 to provide a tire cover that enables artwork to be easily changed, the need to remove the tire cover to replace artwork is an inconvenience. In fact, unless it is trivially simple and convenient to change the image being displayed by a tire cover, an owner is not likely to routinely do so.

### SUMMARY OF THE INVENTION

The present invention provides a vehicle tire cover for displaying decorative and/or informational images (e.g., pictures, drawings, words, numbers, symbols, etc.) while avoiding some of the disadvantages and costs of the prior art.

In accordance with the invention, the vehicle tire cover is physically adapted to enable a vehicle owner to routinely and rapidly change the image being displayed. For example, in some embodiments, the tire cover includes an externally-accessible pouch having a transparent window for displaying an image. The pouch includes a closure mechanism (e.g., a zipper, snaps, hook-and-loop fasteners, etc.) that provides access to the interior of the pouch. The image usually appears on some type of cardboard or vinyl support or backer board. An image being displayed in pouch is readily exchanged for another image by disengaging (e.g., un-zippering, unsnapping, etc.) the closure mechanism, removing the displayed image, inserting a new image, and re-engaging the closure. In fact, in most embodiments, a user need not even remove the tire cover to change the image.

In some other embodiments, the tire cover has two layers that are partially separable from one another. When partially separated, such as by disengaging a closure mechanism, an image can be inserted between the layers and displayed through a transparent window that is disposed in the outermost of the two layers.

The ability to change an image without removing the tire cover makes it very convenient for a user to change, for example, a holiday-related image on a timely basis (e.g., from Labor Day, to Presidents' Day, to Halloween, to Thanksgiving, to New Years, etc.) or for a sports fan to display and regularly rotate the logo of their favorite football, baseball, hockey, and basketball teams.

### BRIEF DESCRIPTION OF THE DRAWINGS

FIG. 1 depicts a sport utility vehicle with a vehicle tire cover in accordance with the illustrative embodiment of the present invention.

FIG. 2 depicts a side view of the vehicle tire cover of FIG. 1, wherein the tire cover includes a pouch in for displaying an image.

FIG. 3 depicts the vehicle tire cover of FIGS. 1 and 2, wherein a first image is being removed from the pouch and a second image being inserted therein.

FIGS. 4 and 5 depict further details of an embodiment of the pouch of FIG. 2, illustrating the operation of a closure mechanism that provides access to the interior of the pouch.

FIG. 6 depicts a first implementation of the pouch of FIG. 2.

FIG. 7 depicts a second implementation of the pouch of FIG. 2.

FIG. 8 depicts a first alternative embodiment of a vehicle tire cover.

FIG. 9 depicts a second alternative embodiment of a vehicle tire cover.

FIG. 10 depicts a third alternative embodiment of a vehicle tire cover.

FIG. 11 depicts a kit comprising a vehicle tire cover and several images for use therewith.

### DETAILED DESCRIPTION

The following terms are defined for use in this Specification, including the appended claims:
Coupled means “directly or indirectly attached.” For example, if a mirror is described as being “coupled to a door,” this would encompass the following embodiments, among any others:
   a piece of mirrored glass is fitted within an opening in the door;
   a piece of mirror glass is disposed in a frame, and the frame and the mirrored glass are fitted within an opening in the door;
   a piece of mirror glass is disposed in a frame, and the frame and the mirrored glass are attached to the surface of a door by clips.
In other words, the coupled item does not need to be in direct physical contact with the item it is being coupled to.
Supported image means a support or backer material that bears an image. The support can be rigid or flexible, and, in various embodiments, is vinyl, cardboard, or the like. The “image” itself can be any visual representation (e.g., a photograph, a painting, a drawing, words, letters, numbers, characters, etc.) that the owner of a vehicle would like to display. Non-limiting examples of images include a holiday greeting, the logo, name or other indicia of a sports team, the name of the manufacturer of the vehicle bearing the vehicle tire cover, pictures of family members of the vehicle owner, and an image of a favorite dog breed. The image can be applied to the support using any of a variety of well-known techniques, such as silk screening or various printing techniques. Furthermore, the image can be applied by the user, such as by hand-painting on the support, or taping a picture to the support, etc.

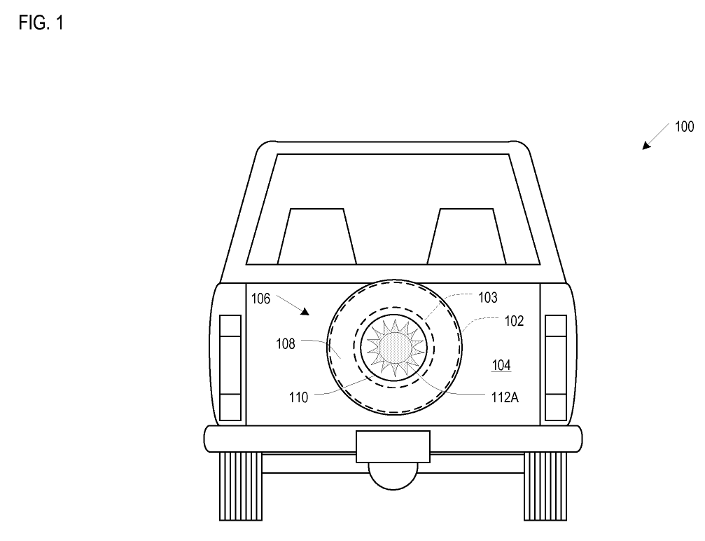

FIG. 1 depicts a view of the back of sport utility vehicle 100. Spare tire 102 and wheel 103 is disposed on tail gate or hatch 104 of vehicle 100. The spare tire and wheel are typically coupled to tail gate 104 via brackets, etc., (not depicted) in well-known fashion. Vehicle tire cover 106 is depicted covering spare tire 102.

In the illustrative embodiment that is depicted in FIG. 1, vehicle tire cover 106 comprises a flexible, visually opaque, and weatherproof layer 108 of material. This layer shrouds the otherwise exposed sidewall and tread of spare tire 102 as well as accompanying wheel 103, thereby protecting it from the elements. In various embodiments, layer 108 comprises a heavy-duty vinyl or other suitable polymer fabric, canvas, or the like.

Vehicle tire cover 106 includes window 110 through which supported image 112A is visible. Window 110 comprises a transparent material, such as a clear plastic, vinyl, or the like.

In accordance with the illustrative embodiment, vehicle tire cover 106 includes structural adaptations that enable a user to quickly and easily change any particular supported image that is displayed through window 110 for another supported image. In some embodiments, the exchange of supported images can be performed while vehicle tire cover 106 is covering the spare tire.

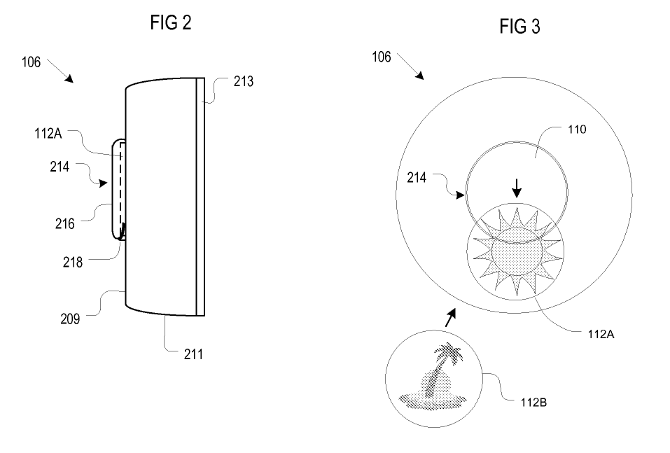

An example of an embodiment of vehicle tire cover 106 that provides rapid and easy exchange of supported images is depicted in FIGS. 2 (side view) and 3 (front view).

Referring now to FIG. 2, pouch 214 is depicted on outward-facing surface of layer 108 of tire cover 106. Pouch 214 is suitably sized to receive a supported image, such as supported image 112A, which is shown therein. Outer wall 216 of pouch 214 comprises a transparent material, thereby serving as window 110 through which supported image 112A is viewable. Pouch 214 incorporates closure mechanism 218, such as a zipper, snaps, hook and loop fastener (Velcro®), or the like.

In some embodiments, tire-shrouding layer 108 comprises discrete circular face portion 209 and discrete side portion 211 that are suitably attached to one another (e.g., sewing, heat bonding, etc.). In some other embodiments, layer 108 comprises a single piece of material. Elastic banding 213 can be fitted near a marginal region of vehicle tire cover 106 to ensure that when placed on spare tire 102, the tire cover remains in place even while vehicle 100 is in motion or in otherwise windy conditions.

FIG. 3 depicts the exchange of two supported images, wherein supported image 112A is removed from pouch 214 of tire cover 106 and supported image 112B is inserted into the pouch.

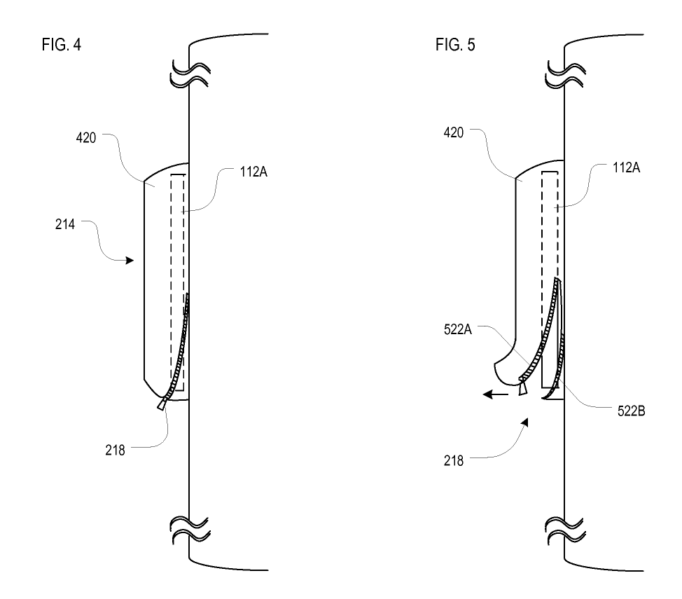

FIGS. 4 and 5 depict the operation of an embodiment of closure mechanism 218. The closure mechanism provides access to interior region 420 of pouch 214 to facilitate insertion or removal of supported images, such as supported images 112A and 112B (e.g., see, FIG. 3). In this embodiment, closure mechanism 218 is a zipper. Zipper halves 522a and 522b (FIG. 5) are attached to the pouch 214 in any appropriate manner, such as via stitching or heat fusion.

FIG. 4 depicts closure mechanism 218 in an engaged state. In this state, interior region 420 of pouch 214 is sealed against the elements (e.g., rain, dirt, etc.), thereby protecting supported image 112A that is disposed therein. FIG. 5 depicts closure mechanism 218 in a disengaged state, such that interior region 420 is accessible to insert or withdraw a supported image, such as supported image 112A.

Closure mechanism 218 is preferably disposed on the lower portion of pouch 214, thereby shielding the closure mechanism to some degree from falling rain. This reduces the likelihood that falling rain will penetrate pouch 214 through the closure mechanism and potentially damage the supported image therein. It is notable that since closure mechanism 218 is disposed on pouch 214, and since the pouch is accessible from the exterior of tire cover 106, supported images (e.g., supported images 112A and 112B of FIG. 3) can be:
exchanged by simply disengaging (e.g., un-zippering, etc.) closure mechanism 218; and
exchanged while tire cover 106 remains on the spare tire.

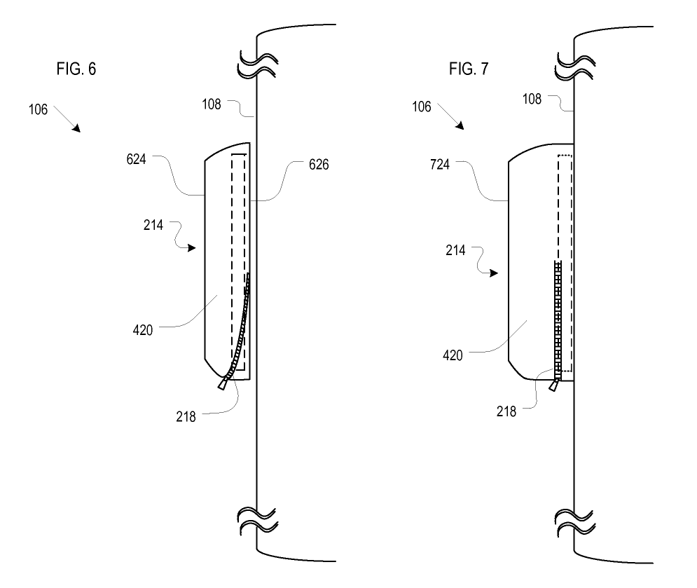

FIGS. 6 and 7 depict two different structural implementations of pouch 214. In the embodiment that is depicted in FIG. 6, pouch 214 comprises outer wall 624 and inner wall 626. The inner wall is attached to exterior surface of layer 108 by any suitable method, such as stitching or heat fusion, as known to those skilled in the art. In this Figure, pouch 214 is shown separated from layer 108 of cover 106 to clearly depict layer 626 as being discrete from layer 108.

In the embodiment that is depicted in FIG. 7, pouch 214 is formed by attaching outer wall 724 to layer 108. In other words, there is no “inner wall” (such as wall 626 in FIG. 6) apart from that provided by a portion of layer 108. Regardless of implementation, pouch 214 defines protected interior region 420 for receiving a supported image and includes closure mechanism 218.

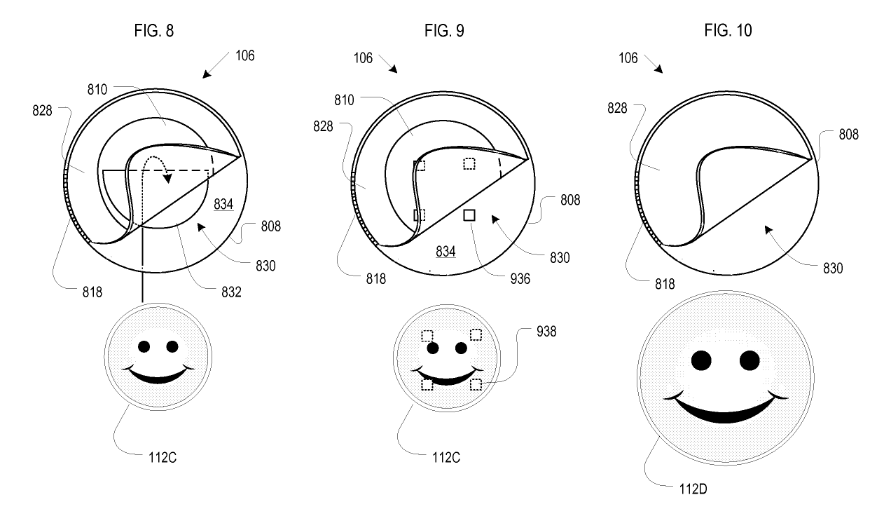

FIGS. 8, 9, and 10 depict further embodiments of vehicle tire cover 106 in accordance with the present invention. The embodiments that are depicted in these Figures do not incorporate a pouch that is disposed on outward-facing surface of layer 108. Rather, for these embodiments, a “pouch” or otherwise reversibly-sealable region is effectively created between an inner layer, such as layer 808, and a second layer 828 of material that is disposed over layer 808. Layer 808 can be formed from the same type of material as layer 108 (e.g., heavy-duty vinyl or other suitable polymer fabric, canvas, or the like).

In the embodiments that are depicted in FIGS. 8-10, layer 828 has a circular shape with a diameter that is about the same as the diameter of the spare tire. In other words, layer 828 is analogous to discrete circular face portion 209 of FIG. 2. Closure mechanism 818 is disposed at the periphery of layer 828. The closure mechanism serves to at least partially reversibly-couple layers 808 and 828 to one another, thereby providing access to region 830 therebetween.

Region 830 receives a supported image, such as supported image 112C. Closure mechanism 818 is suitably implemented in various embodiments as snaps, a zipper, hook-and-loop fastener, or like and is advantageously disposed on the lower portion of the periphery of layer 828.

In the embodiments that are depicted in FIGS. 8 and 9, layer 828 incorporates centrally-located window 810, which can be formed from transparent plastic, vinyl, or the like. The annular region of material of layer 828 that surrounds window 810 can be the same type of material that is used for layer 808. In these embodiments, a retention mechanism is used to fix a supported image in registration with window 810 so that it remains viewable.

In the embodiment that is depicted in FIG. 8, the retention mechanism comprises retainer 832. The retainer is a piece of transparent material having a semicircular shape that is disposed on surface 834 of layer 808. Retainer 832 is in registration with window 810 and is appropriately-sized to receive a supported image, such as supported image 112C. When disposed in retainer 832, the supported image is viewable through window 810. Retainer 832 can be formed of the same material as window 810.

In the embodiment that is depicted in FIG. 9, the retention mechanism is small sections 936 of hook-and-loop fastener that are disposed on surface 834 of layer 808 in registration with window 810. Additional sections 938 of hook-and-loop fastener are disposed on the back of supported image 112C. Sections 938 are situated so that they register with sections 936 of hook-and-loop fastener on layer 808. The coupled sections 936 and 938 fix a supported image beneath window 810.

In some embodiments, no retention mechanism is used to maintain supported image 112C in registration with window 810. Rather, if appropriate materials are used, supported image 112C will “stick” to window 810, such that a separate retention mechanism is not required. For example, if both window 810 and supported image 112C are formed from vinyl, they will tend to adhere to one another sufficiently to prevent movement, but will readily detach when a user wishes to exchange supported images.

In the embodiment that is depicted in FIG. 10, there is no centrally-located window 810 in layer 828. In this embodiment, the full extent of layer 828 is transparent. A larger supported image 112D is used in conjunction with this embodiment; the diameter of supported image 112D is slightly smaller than the diameter of layer 828 so that the supported image can fit in region 830 between layers 828 and 808.

In a further embodiment, not depicted, layer 828 can extend over the sidewalls of the spare tire so that this layer is coextensive with layer 808. Elastic banding can be disposed at the periphery of layer 828, such that it will secure layer 828 to the spare tire in the same manner as layer 808 (ala layer 108 with marginally-located elastic banding 213). In this embodiment, inserting a supported image between layer 828 and layer 808 requires that layer 828 is partially removed from the spare tire so that the supported image can be inserted between the layers. Layer 828 is re-secured over the spare tire via the elastic banding.

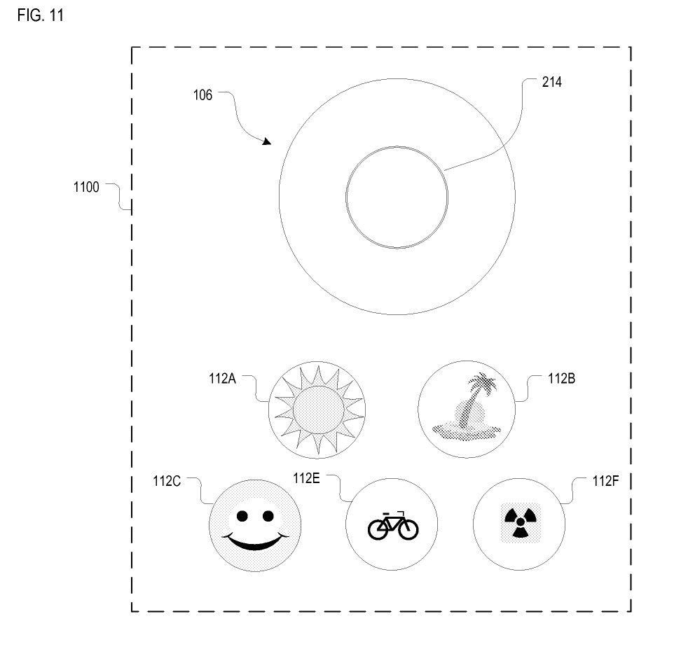

FIG. 11 depicts a vehicle-tire cover kit 1100, such as can be made available for sale to consumers, comprising vehicle-tire cover 106 and a plurality of supported images 112A, 112B, 112C, 112E, and 112F. The supported images are dimensioned to be received in and displayed through pouch 214. It is to be understood that in some other embodiments, kit 1100 includes a different embodiment of vehicle-tire cover 106, such as the other embodiments disclosed herein, and/or different embodiments of supported images.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A vehicle tire cover comprising:
at least a first layer of a visually-opaque material, wherein said first layer is dimensioned and arranged to fit over a spare tire of a motor vehicle;
a transparent material, wherein said transparent material is coupled to said first layer of visually-opaque material and defines a window; and
a closure mechanism, wherein:
(a) said closure mechanism provides access to a region behind said transparent material;
(b) said closure mechanism is accessible while said tire cover is disposed on said spare tire;
(c) said region is dimensioned and arranged to a receive a supported image; and
(d) said supported image is visible through said transparent material when said supported image is disposed in said region.

2. The vehicle tire cover of claim 1 wherein said transparent material is incorporated into and substantially co-planar with said first layer.

3. The vehicle tire cover of claim 2 further comprising a second layer of material, wherein first layer and said second layer are at least partially reversibly coupled to one another via said closure mechanism.

4. The vehicle tire cover of claim 3 wherein hook and loop fastener is disposed on said second layer of material on a surface thereof that faces an inward-facing surface of said first layer, and said hook and loop fastener is in registration with said transparent material.

5. The vehicle tire cover of claim 1 wherein said transparent material overlies said first layer of visually-opaque material.

6. The vehicle tire cover of claim 1 further comprising a pouch, wherein said pouch incorporates said transparent material and defines said region.

7. The vehicle tire cover of claim 6 wherein said pouch is disposed on an outward-facing surface of said first layer of visually-opaque material.

8. The vehicle tire cover of claim 6 wherein said pouch is defined by an outer wall and an inner wall, and wherein said outer wall comprises said transparent material and said inner wall comprises a portion of said visually-opaque material, and further wherein said region is defined between said outer wall and said inner wall.

9. The vehicle tire cover of claim 8 wherein said closure reversibly couples said outer wall and said inner wall, thereby providing access to said region defined therebetween.

10. The vehicle tire cover of claim 6 wherein said pouch is defined by an outer wall and an inner wall, and wherein said outer wall comprises said transparent material and said inner wall comprises a backing layer, wherein said backing layer is disposed on an outward-facing surface of said visually-opaque material, and further wherein said region is defined between said outer wall and said inner wall.

11. The vehicle tire cover of claim 10 wherein said closure reversibly couples said outer wall and said inner wall, thereby providing access to said region defined therebetween.

12. The vehicle tire cover of claim 1 further comprising said first supported image, wherein said first supported image appears on a first discrete support, and wherein said first supported image is dimensioned and arranged to be removably inserted into said region when said closure mechanism is disengaged.

13. The vehicle tire cover of claim 1 further comprising a second supported image, wherein said second supported image appears on a second discrete support, and wherein said second supported image is dimensioned and arranged to be removably inserted into said region when said closure mechanism is disengaged.

14. A vehicle tire cover kit, said kit comprising:
a plurality of supported images, wherein each supported image comprises:
(a) a discrete support;
(b) an image, wherein said image is disposed on said discrete support, and further wherein said image that is disposed on any one of said discrete supports is different than at least some of said images disposed on other of said discrete supports;
a cover, wherein said cover is dimensioned and arranged to fit over a spare tire of a motor vehicle;
a pouch that is dimensioned and arranged to receive said supported images, wherein said pouch is coupled to said cover, and further wherein said pouch comprises a transparent material through which said supported images are viewable; and
a closure mechanism that provides access to an interior of said pouch from an exterior of said cover.

15. The vehicle tire cover kit of claim 14, wherein said pouch is disposed on said exterior of said cover.

16. The vehicle tire cover kit of claim 14 wherein said pouch is defined by an outer wall and an inner wall, and wherein said outer wall comprises said transparent material and said inner wall comprises a portion of said cover.

17. The vehicle tire cover kit of claim 14 wherein said pouch is defined by an outer wall and an inner wall, and wherein said outer wall comprises said transparent material and said inner wall comprises a backing layer, wherein said backing layer is disposed on said cover.

18. A vehicle tire cover comprising:
at least a first layer of a visually-opaque material, wherein said first layer is dimensioned and arranged to fit over a spare tire of a motor vehicle;
a pouch, wherein said is coupled to said first layer, and wherein said pouch is dimensioned and arranged to receive a first supported image, and further wherein said pouch comprises a transparent material through which said first supported image is viewable; and
a closure mechanism, wherein said closure mechanism provides access to an interior of said pouch from an exterior of said cover, and further wherein said closure mechanism is physically adapted to enable said first supported image to be inserted into or removed from said pouch when said closure mechanism is disengaged.

19. The vehicle tire cover of claim 18 further comprising said first supported image and a second supported image, wherein said each of said first supported image and said second supported image are different from one another.
